(19) United States
(12) Patent Application Publication
(10) Pub. No.: US 2008/0284238 A1
(43) Pub. Date: Nov. 20, 2008

(54) COLORED BICYCLE WHEEL RIM

(75) Inventors: TOMOHIKO NISHIMURA, Kaizuka City (JP); Takashi Otsuji, Takaishi City (JP)

Correspondence Address: DELAND LAW OFFICE, P.O. BOX 69, KLAMATH RIVER, CA, 96050-0069, US

(73) Assignee: SHIMANO, INC., Osaka (JP)

(21) Appl. No.: 11/748,075

(22) Filed: May 14, 2007

(51) Int. Cl. B60B 21/00

(52) U.S. Cl. 301/95.101

(57) ABSTRACT

A bicycle wheel rim comprises a ring-shaped wheel rim body having a rotational axis. A colored surface is formed by dipping the rim body in a coloring agent so that a first color difference portion and a second color difference portion are formed on opposite sides of the rim body.

### BACKGROUND OF THE INVENTION

The present invention is directed to bicycles and, more particularly, to a bicycle wheel rim with colored portions.

Bicycling is becoming an increasingly popular form of recreation as well as a means of transportation. Moreover, bicycling also has become a very popular competitive sport for both amateurs and professionals. Whether the bicycle is used for recreation, transportation or competition, the bicycle industry is constantly improving the various components of the bicycle. For example, bicycle wheels have been extensively redesigned over the past few years to be lightweight and more aerodynamic as well as to be simple to manufacture and assemble.

There are many different types of bicycle wheels currently available on the market. The most basic type of bicycle wheel comprises a hub portion, a plurality of spokes, and an annular rim. The hub portion is attached to a part of the bicycle frame for relative rotation. The inner ends of the spokes are coupled to the hub portion, and the outer ends of the spokes are coupled to the rim. A pneumatic tire is mounted to the outer peripheral portion of the rim.

The rim typically comprises a ring-shaped rim body formed from a lightweight metal such as aluminum. Some rims are formed from a composite material. However, regardless of the material used to construct the rim, the appearance of the rim is very important. The typical rim has a single uniform color determined by the materials used to construct the rim. For example, standard aluminum rims are uniformly silver in color, and some anodized aluminum rims have a dark gray or black color. For aesthetic purposes, it is desirable to have some variety in the coloration of the rim, but manually applying color to the rim can be very labor intensive.

### SUMMARY OF THE INVENTION

The present invention is directed to various features of a bicycle wheel rim. In one embodiment, a bicycle wheel rim comprises a ring-shaped wheel rim body having a rotational axis. A colored surface is formed by dipping the rim body in a coloring agent so that a first color difference portion and a second color difference portion are formed on opposite sides of the rim body. Additional inventive features will become apparent from the description below, and such features alone or in combination with the above features and their equivalents may form the basis of further inventions as recited in the claims.

### BRIEF DESCRIPTION OF THE DRAWINGS

FIG. 1 is a side view of a particular embodiment of a bicycle;

FIG. 2 is a flow chart illustrating a method of constructing a wheel rim body with colored portions;

FIG. 3 shows the wheel rim body immersed in an anodizing bath;

FIG. 4 shows the wheel rim body dipped in a coloring agent;

FIG. 5 is a side view of the wheel rim body showing first and second color difference portions;

FIG. 6 is a side view of the wheel rim body showing third and fourth color difference portions;

FIG. 7 is a view taken along line 7-7 in FIG. 6 showing a color difference portion formed by the application of a fluid coloring agent; and

FIG. 8 is a view taken along line 8-8 in FIG. 6 showing a color difference portion formed by the application of a cover element.

### DETAILED DESCRIPTION OF THE EMBODIMENTS

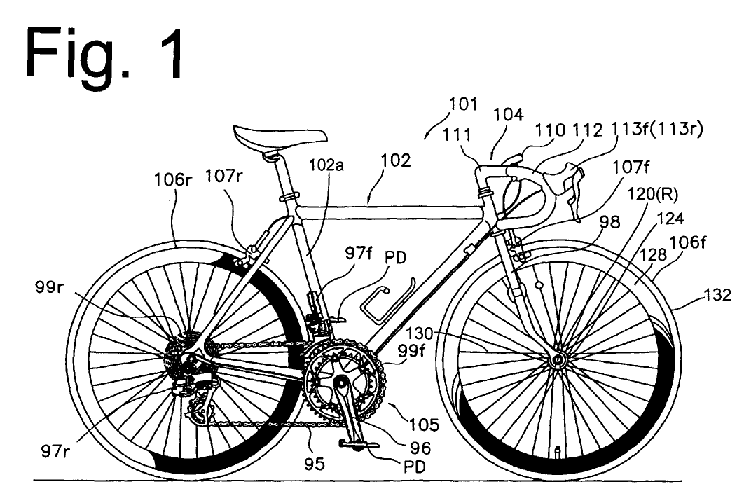

FIG. 1 is a side view of a bicycle 101. Bicycle 101 is a road bicycle comprising a diamond-shaped frame 102, a front fork 98 rotatably mounted to frame 102, a handlebar assembly 104 mounted to the upper part of fork 98, a front wheel 106f rotatably attached to the lower part of fork 98, a rear wheel 106r rotatably attached to the rear of frame 102, and a drive unit 105. A front wheel brake 107f is provided for braking front wheel 106f, and a rear wheel brake 107r is provided for braking rear wheel 106r.

Drive unit 105 comprises a chain 95, a front sprocket assembly 99f coaxially mounted with a crank 96 having pedals PD, an electrically controlled front derailleur 97f attached to a seat tube 102a of frame 102, a rear sprocket assembly 99r coaxially mounted with rear wheel 106r, and an electrically controlled rear derailleur 97r. Front sprocket assembly 99f comprises two coaxially mounted sprockets, and rear sprocket assembly 99r comprises ten sprockets mounted coaxially with an axle of rear wheel 106r. Front derailleur 97f moves to two operating positions to switch chain 95 between the two front sprockets, and rear derailleur 97r moves to ten operating positions to switch chain 95 among selected ones of the ten rear sprockets.

A handlebar stem 111 is mounted to the upper portion of front fork 98, and a drop-style handlebar 112 is mounted to a front portion of handlebar stem 111. A combined brake and shift control device 113f is mounted to the left side of handlebar 112 to control the operation of front derailleur 97f and front brake 107f, and a combined brake and shift control device 113r is mounted to the right side of handlebar 112 to control the operation of rear derailleur 97r and rear brake 107r. An electronic control unit 110 provides the appropriate electrical signals to front derailleur 97f an rear derailleur 97r in response to the operation of the shift control devices in combined brake and shift control devices 113f and 113r in a known manner.

Front wheel 106f comprises a hub axle 120 defining a rotational axis R, a wheel hub 124 supported to hub axle 120 for rotation around rotational axis R, a ring-shaped rim body 128, a plurality of spokes 130 that attach wheel hub to rim body 128 in a conventional manner, and a tire 132 fitted around the outer circumference of rim body 128. Rear wheel 106r also has a conventional structure, including conventional structure that supports the plurality of rear sprockets 99r. Since the relevant features are directed to rim body 128, a further description of the other structures shall be omitted.

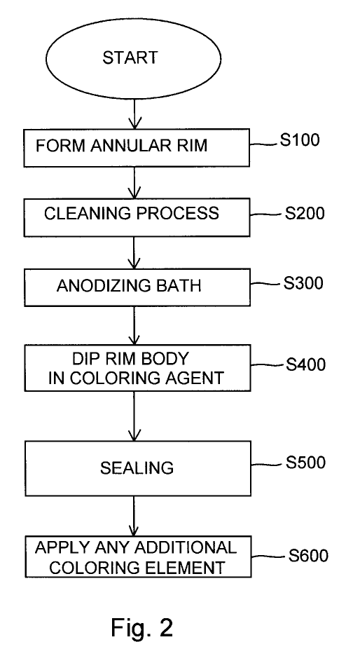

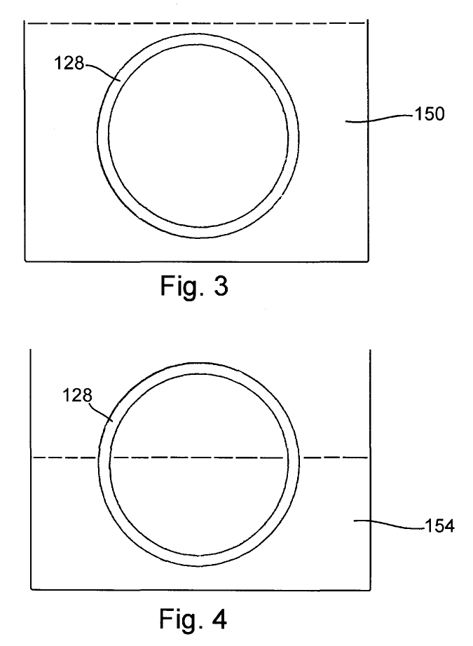

In this embodiment, rim body 128 is constructed from, e.g., an aluminum alloy, but other materials may be used. FIG. 2 illustrates a method of manufacturing rim body 128. First, in step S100, rim body 128 may be formed by extruding a length of aluminum with the desired cross-sectional shape, bending the extruded aluminum into a ring-shape, and welding the ends of the rim body together. In step S200, rim body 128 undergoes a conventional cleaning process. In step S300, rim body 128 is immersed in a conventional anodizing bath 150 as shown in FIG. 3 to anodize the rim body surface. In step S400, rim body 128 is dipped partially in a coloring agent 154 as shown in FIG. 4. Coloring agent 154 may be any material in any phase sufficient to impart a color to rim body 128. For example, coloring agent 154 may be a liquid including a dye having predetermined coloring, a paint that immediately imparts a color upon drying, a coloring agent that is transparent until it is exposed to some other environment, a gas that applies color or etches rim body 128 to produce a color effect, and so on. After step S400, a conventional sealing treatment is performed in a step S500 in FIG. 2.

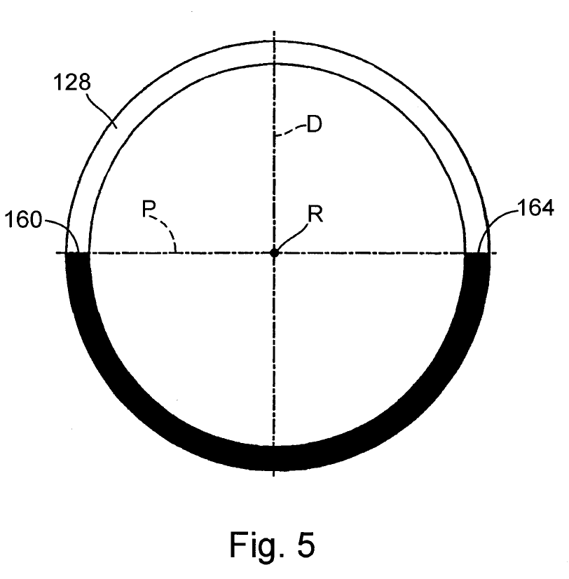

The resulting rim body 128 with a continuous arcuate colored portion 158 is shown in FIG. 5. When the coloring is expressed, rim body 128 includes a first color difference portion 160 and a second color difference portion 164 formed on opposite sides of rim body 128. It should be noted that first color difference portion 160 and second color difference portion 164 usually form a color contrast, but the color difference also can be determined by the difference in material used to form the color difference portions. To be on opposite sides of rim body, first color difference portion 160 and second color difference portion 164 only need to be on opposite sides of an arbitrary straight phantom dividing line D that passes through rotational axis R. Thus, for example, first color difference portion 160 and second color difference portion 164 do not have to be equidistant from dividing line D. In this embodiment, because of the dipping method used, first color difference portion 160 and second color difference portion 164 are formed as distinct color contrast borders that are substantially straight, and first color difference portion 160 and second color difference portion 164 substantially align with a straight phantom line P. Of course, depending upon the nature of the coloring agent and the method used to apply the coloring agent, first color difference portion 160 and second color difference portion 164 may be somewhat diffuse areas, in which case it is only necessary that phantom line P intersect both color difference portions. Also, phantom line P need not pass through rotational axis R, and first color difference portion 160 and second color difference portion 164 may be disposed at any location and orientation along rim body 128 and need not be located midway as shown.

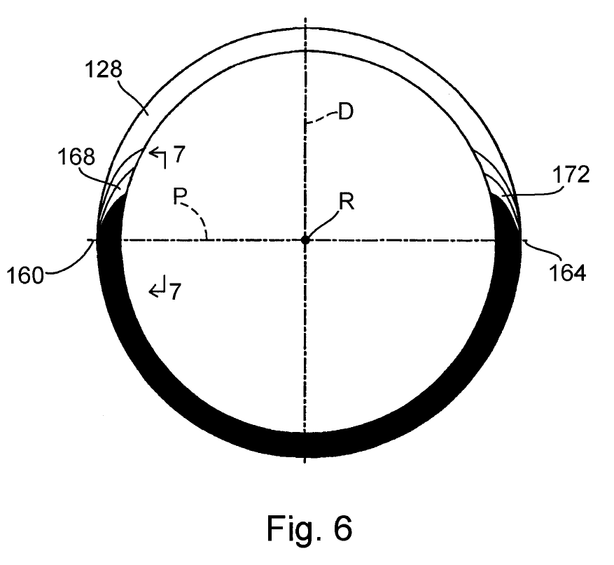

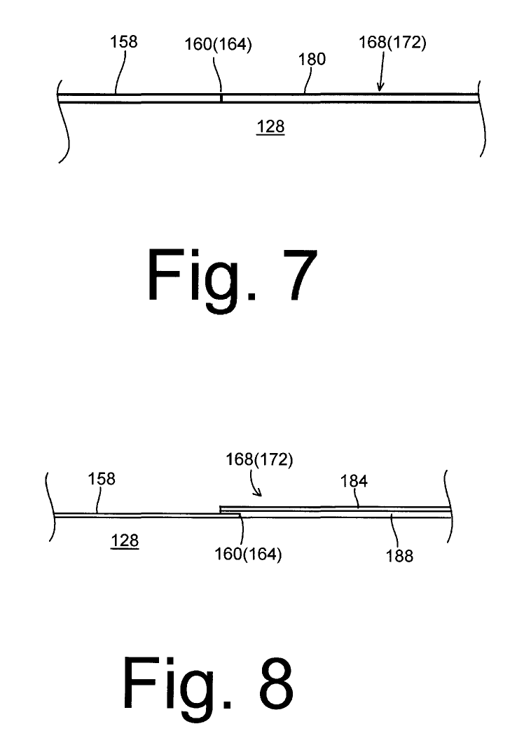

If desired, rim body 128 may be considered aesthetically complete at this time. However, if desired, step S600 in FIG. 2 may be performed wherein one or more additional color difference portions may be added to rim body 128. For example, as shown in FIG. 6, a third color difference portion 168 and a fourth color differences portion 172 may be added to produce a more pleasing aesthetic effect. In this case, third color difference portion 168 and fourth color difference portion 172 form discrete contrast borders that extend to some extent circumferentially along rim body 128. As shown in FIG. 7, third color difference portion 168 and/or fourth color difference portion 172 may be formed by applying a color difference element such as a fluid 180 (e.g., paint) in close proximity to, adjacent to, or covering first color difference portion 160 and second color difference portion 164, respectively. When fluid 180 is placed over first color difference portion 160 and/or second color difference portion 164, first color difference portion 160 and second color difference portion 164 still exist; they are simply covered. Alternatively, third color difference portion 168 and/or fourth color difference portion 172 may comprise a cover member 184 as shown in FIG. 8. Cover member 184 may comprise a flexible layer material attached to rim body 128 with, e.g., an adhesive 188. Any other combination of methods for forming additional color difference portions may be employed as well.

While the above is a description of various embodiments of inventive features, further modifications may be employed without departing from the spirit and scope of the present invention. For example, the size, shape, location or orientation of the various components may be changed as desired. Components that are shown directly connected or contacting each other may have intermediate structures disposed between them. The functions of one element may be performed by two, and vice versa. The structures and functions of one embodiment may be adopted in another embodiment. It is not necessary for all advantages to be present in a particular embodiment at the same time. Every feature which is unique from the prior art, alone or in combination with other features, also should be considered a separate description of further inventions by the applicant, including the structural and/or functional concepts embodied by such feature(s). Thus, the scope of the invention should not be limited by the specific structures disclosed or the apparent initial focus or emphasis on a particular structure or feature.

1-11. (canceled)

12. A method of making a bicycle wheel rim comprising the steps of:
forming a ring-shaped wheel rim body having a rotational axis; and
dipping the rim body in a coloring agent to form a colored surface so that a first color difference portion and a second color difference portion are formed on opposite sides of the rim body.

13. The method according to claim 12 wherein the first color difference portion and the second color difference portion are formed on opposite sides of the rim when viewed along the rotational axis.

14. The method according to claim 13 wherein a straight phantom line intersects the first color difference portion and the second color difference portion.

15. The method according to claim 14 wherein the first color difference portion comprises a first contrast border, wherein the second color difference portion comprises a second contrast border, and wherein the phantom line intersects the first contrast border and the second contrast border.

16. The method according to claim 15 wherein both the first contrast border and the second contrast border substantially align with the phantom line.

17. The method according to claim 15 further comprising the step of applying a first color difference element at the first color difference portion to form a third color difference portion.

18. The method according to claim 17 wherein the first color difference element comprises a cover element.

19. The method according to claim 18 wherein the applying step comprises the step of attaching the first cover element to the wheel rim body with an adhesive.

20. The method according to claim 19 wherein the cover element comprises a flexible layer material.

21. The method according to claim 18 wherein the third color difference portion comprises a third contrast border.

22. The method according to claim 21 wherein the third contrast border extends circumferentially along the wheel rim body.

23. The method according to claim 12 wherein the rim comprises a metal rim.

24. The method according to claim 23 wherein the rim body comprises an aluminum rim.

25. The method according to claim 12 wherein the coloring agent comprises a liquid dye.

26. The method according to claim 12 wherein the coloring agent comprises paint.

27. The method according to claim 12 wherein the coloring agent comprises a coloring agent that forms a color when exposed to an environment other than the coloring agent itself

28. The method according to claim 12 wherein the coloring agent comprises a gas.

29. The method according to claim 17 wherein the first color difference element comprises a fluid.

30. The method according to claim 29 wherein the first color difference element comprises paint.

31. The method according to claim 17 wherein the first color difference element originates in close proximity to the first color difference portion and has opposite circumferential ends that terminate in proximity to the first color difference portion so that the entire first color difference element is disposed in proximity to the first color difference portion.
